(19) United States
(12) Patent Application Publication
(10) Pub. No.: US 2017/0181044 A1
(43) Pub. Date: Jun. 22, 2017

(54) METHOD, BASE STATION, AND DUAL CONNECTIVITY SYSTEM FOR PROVIDING SERVICES TO HANDOVER OF A USER EQUIPMENT

(71) Applicant: Alcatel Lucent, Boulogne-Billancourt (FR)

(72) Inventors: Pingping Wen, Shanghai (CN); Chandrika Worrall, Newbury (GB); Tao Yang, Shanghai (CN)

(73) Assignee: Alcatel Lucent, Boulogne Billancourt (FR)

(21) Appl. No.: 15/115,444

(22) PCT Filed: Jan. 19, 2015
(86) PCT No.: PCT/IB2015/000187

§ 371 Date: Jul. 29, 2016

(30) Foreign Application Priority Data
Jan. 30, 2014 (CN) 201410044587.6

(51) Int. Cl. H04W 36/00; H04W 76/02; H04W 76/06

(52) U.S. Cl. CPC H04W 36/0027; H04W 76/064; H04W 76/028

(57) ABSTRACT

The present invention provides a method, base station, and dual connectivity system for providing service to handover of a user equipment. Through releasing and adding operations of the secondary base station and solving the data transmission issue in the process, the present invention provides a solution for handover of the user equipment between cells or base stations in a plurality of cases in a dual connectivity system.

### FIELD OF THE INVENTION

The present invention relates to the field of communication technologies, and more specifically to a method, base station, and dual-connectivity system for providing services to handover of a user equipment.

### BACKGROUND OF THE INVENTION

In the dual connectivity system, the user equipment would generally have a dual/multi connectivity with a master cell and a secondary sell. Generally, the user equipment is connected to the macro cell for maintaining the mobility robustness, and the user equipment performs split traffic through a second connectivity with the small cell. When the user equipment moves into the coverage of the macro cell and the small cell, because the user equipment supports dual connectivity, the handover between cells and/or base stations of user equipment would become complex.

However, in the prior art, a handover solution for the user equipment in the dual connectivity system is not provided.

### SUMMARY OF THE INVENTION

An objective of the present invention is providing a method, a base station, and a dual connectivity system for providing services to handover of a user equipment.

According to one aspect of the present invention, there is provided a method for handing over a user equipment to a target base station from a source base station in a dual connectivity system, wherein both of the source base station and the target base station support a dual connectivity configuration, the method comprising steps of:
after determining, with a target base station, that the user equipment needs handover, transmitting, by the source base station, connection reconfiguration information to the user equipment, and transmitting a release request to a secondary base station jointly providing the dual connectivity service to the user equipment with the source base station;
transmitting, by the secondary base station of the source base station, a release response to the source base station;
transmitting, by the source base station, an SN status to the target base station, and forwarding data about the user equipment;
receiving, by the target base station, the transmitted SN status and the forwarded data from the source base station, and establishing a connection with the user equipment;

wherein the method further comprises steps of:
transmitting, by the target base station, an add request to a base station, which add request is for requesting adding this base station as a secondary base station jointly providing the dual connectivity service to the user equipment with the target base station;
transmitting, by the base station receiving the add request, an add response to the target base station, so as to establish a connection with the user equipment as the secondary base station of the target base station.

According to another aspect of the present invention, there is provided a method for handing over a user equipment from a source base station to a target base station in a dual connectivity system, wherein the source base station supports dual-connectivity configuration, the target base station does not support a dual-connectivity configuration, the method comprising steps of:
after determining, with the target base station, that the user equipment needs handover, transmitting, by the source base station, connection reconfiguration information to the user equipment, and transmitting a release request to a secondary base station jointly providing the dual connectivity service for the user equipment with the source base station;
transmitting, by the secondary base station of the source base station, a release response to the source base station, and transmitting its SN status and forwarding data about the user equipment to the source base station or the target base station;
transmitting, by the source base station, the SN status and forwarding data about the user equipment to the target base station, which SN status and data include the SN status and data of the source base station itself, or include the SN status and data of the source base station itself and the SN status and data transmitted from the secondary base station to the source base station;
receiving, by the target base station, the transmitted SN status and the forwarded data from the source base station, or from the source base station and the secondary base station, and establishing a connection with the user equipment.

According to a further aspect of the present invention, there is provided a method of handing over a user equipment from a source base station to a target base station in a dual connectivity system, wherein the source base station supports a dual connectivity configuration, the secondary base station jointly providing service to the user equipment with the source base station under the dual connectivity configuration is the same base station as the target base station, the method comprising steps of:
after determining, with the target base station, that the user equipment needs handover, transmitting, by the source base station, connection reconfiguration information to the user equipment, and transmitting a release request to the secondary base station, which release request is for requesting the secondary base station to release its connection with the user equipment;
transmitting, by the secondary base station, a release response to the source base station, and storing its SN status and the data about the user equipment into itself;
transmitting, by the source base station, the SN status to the target base station, and forwarding data about the user equipment;
receiving, by the target base station, the transmitted SN status and the forwarded data from the source base station, and establishing a connection with the user equipment.

According to a further aspect of the present invention, there is provided a method for handing over a user equipment from a source base station to a target base station in a dual connectivity system, wherein the target base station supports a dual connectivity configuration, which source base station does not support the dual-connectivity configuration, the method comprising steps of:
transmitting, by the source base station, a handover request to the target base station;
transmitting, by the target base station, a handover request acknowledgement to the source base station;
transmitting, by the source base station, SN status to the target base station, and forwarding data about the user equipment, and transmitting connection reconfiguration information to the user equipment;
receiving, by the target base station, the transmitted SN status and the forwarded data from the source base station, and establishing a connection with the user equipment;

wherein the method further comprises steps of:
transmitting, by the target base station, an add request to a base station, which add request is for requesting for adding this base station as a secondary base station that jointly provides, with the target base station, the dual connectivity service to the user equipment;
transmitting, by the base station receiving the add request, an add response to the target base station, so as to establish a connection with the user equipment as the secondary base station of the target base station.

According to a further aspect of the present invention, there is provided a method of handing over a user equipment from one cell to a further cell in a dual connectivity system, wherein the cell and the further cell belong to the same base station, and the base station supports dual connectivity configuration, the method comprising steps of:
transmitting, by the base station, a release request to the secondary base station jointly providing the dual connectivity service to the user equipment with the base station, if it is determined that the user equipment needs to handover from one cell of the base station to the further cell;
transmitting, by the secondary base station, a release response to the base station;
transmitting, by the base station, an add request to the secondary base station after the handover of the user equipment is completed;
transmitting, by the secondary base station, an add response to the base station, thereby reestablishing its connection with the base station.

According to a further aspect of the present invention, there is provided a method for handing over a user equipment from one cell to a further cell, wherein the cell and the further cell belong to the same base station, and the base station supports a dual-connectivity configuration, the method comprising steps of:
transmitting, by the base station, an instruction of stopping transmission to a secondary base station jointly providing a dual connectivity service for the user equipment with the base station, if it is determined that the user equipment needs to handover from one cell to a further cell of the base station;
transmitting, by the base station, reconfiguration information and an instruction of initiating transmission to the secondary base station so as to reestablish the connection between the base station and the secondary base station, and resuming data transmission of the secondary base station, after the handover of the user equipment is completed.

According to a further aspect of the present invention, there is provided a method for changing a secondary base station for a user equipment in a dual connectivity system, wherein the method comprises steps of:
if a master base station determines that a secondary base station that jointly provides a dual-connectivity service to the user equipment therewith needs change, transmitting a release request to the secondary base station;
transmitting, by the secondary base station, a release response to the master base station;
transmitting, by the secondary base station, its SN status and forwarding data about the user equipment;
selecting, by the master base station, one base station to transmit an add request, which add request is for requesting for adding this base station as a secondary base station that jointly provides the dual connectivity service to the user equipment with the master base station;
transmitting, by the base station receiving the add request, an add response to the master base station, so as to be a new secondary base station of the master base station;
receiving, by the new secondary base station, the SN status and the data, and establishing a connection with the user equipment.

According to a further aspect of the present invention, there is provided a dual connectivity system, a user equipment being capable of handing over from the source base station to the target base station in the dual connectivity system, wherein both of the source base station and the target base station support a dual connectivity configuration, the source base station comprising:

a device configured to, after determining, with a target base station, that the user equipment needs handover, transmit connection reconfiguration information to the user equipment, and transmit a release request to a secondary base station jointly providing the dual connectivity service to the user equipment with the source base station;

a device configured to transmit SN status to the target base station, and forward data about the user equipment;

wherein the secondary base station of the source base station comprises:

a device configured to transmit a release response to the source base station;

wherein the target base station comprises:

a device configured to receive the transmitted SN status and the forwarded data from the source base station, and establish a connection with the user equipment;

a device configured to transmit an add request to a base station, which add request is for requesting for adding this base station as a secondary base station jointly providing the dual connectivity service to the user equipment with the target base station;

wherein the secondary base station receiving the add request comprises:

a device configured to transmit an add response to the target base station, so that the base station receiving the add request establishes a connection with the user equipment as the secondary base station of the target base station.

According to another aspect of the present invention, there is provided a dual connectivity system, a user equipment being capable of handing over from a source base station to a target base station in the dual connectivity system, wherein the source base station supports a dual connectivity configuration, the target base station does not support the dual connectivity configuration, the source base station comprising:

a device configured to, after determining, with the target base station, that the user equipment needs handover, transmit connection reconfiguration information to the user equipment, and transmit a release request to a secondary base station jointly providing the dual connectivity service for the user equipment with the source base station;

a device configured to transmit SN status and forward data about the user equipment to the target base station, which SN status and data include the SN status and data of the source base station itself, or include the SN status and data of the source base station itself and the SN status and data transmitted from the secondary base station to the source base station;

wherein the secondary base station of the source base station comprises:

a device configured to transmit a release response to the source base station, and transmit its SN status and forward data about the user equipment to the source base station or target base station;

wherein the target base station comprises:

a device configured to receive the transmitted SN status and the forwarded data from the source base station, or the transmitted SN status and the forwarded data from the secondary base station and the source base station, and establish a connection with the user equipment.

According to a further aspect of the present invention, there is provided a dual connectivity system, a user equipment being capable of handing over from the source base station to the target base station in the dual connectivity system, wherein the source base station supports a dual connectivity configuration, the secondary base station jointly providing service to the user equipment with the source base station under the dual connectivity configuration is the same base station as the target base station, the source base station comprises:

a device configured to, after determining, with the target base station, that the user equipment needs handover, transmit connection reconfiguration information to the user equipment, and transmit a release request to the target secondary base station, which release request is for requesting the target base station to release its connectivity as a secondary base station to the user equipment;

a device configured to transmit SN status to the target base station, and forward data about the user equipment;

wherein the target base station comprises:

a device configured to transmit a release response to the source base station, and store its SN status and the data about the user equipment into itself;

a device configured to receive the transmitted SN status and the forwarded data from the source base station, and establish a connection with the user equipment.

According to a further aspect of the present invention, there is provided a dual connectivity system, a user equipment being capable of handing over from a source base station to a target base station in the dual connectivity system, wherein the target base station supports a dual connectivity configuration, which source base station does not support the dual-connectivity configuration, the source base station comprises:

a device configured to transmit a handover request to the target base station;

a device configured to transmit SN status to the target base station, and forward data about the user equipment, and transmit connection reconfiguration information to the user equipment;

wherein the target base station comprises:

a device configured to transmit a handover request acknowledgement to the source base station;

a device configured to receive the transmitted SN status and the forwarded data from the source base station, and establish a connection with the user equipment;

a device configured to transmit an add request to a base station, which add request is for requesting for adding this base station as a secondary base station that jointly provides, with the target base station, the dual connectivity service to the user equipment;

wherein the base station receiving the add request comprises:

a device configured to transmit an add response to the target base station, such that the base station receiving the add request establishes a connection with the user equipment as the secondary base station of the target base station.

According to a further aspect of the present invention, there is provided a dual connectivity system, a user equipment being capable of handing over from one cell to a further cell in the dual connectivity system, wherein the cell and the further cell belong to the same base station, and the base station supports dual connectivity configuration, the base station comprises:

a device configured to transmit a release request to the secondary base station jointly providing the dual connectivity service to the user equipment with the base station, if it is determined that the user equipment needs to handover from one cell of the base station to the further cell;

a device configured to transmit an add request to the secondary base station, after the handover of the user equipment is completed;

wherein the secondary base station comprises:

a device configured to transmit a release response to the base station; and

a device configured to transmit an add response to the base station, thereby reestablishing its connection with the base station.

According to a further aspect of the present invention, there is provided a base station, a user equipment being capable of handing over from one cell of the base station to a further cell, wherein the cell and the further cell belong to the same base station, and the base station supports a dual connectivity configuration, the base station comprises:

a device configured to, if it is determined that the user equipment needs to handover from one cell of the base station to a further cell, transmit an instruction of stopping transmission to a secondary base station jointly providing a dual connectivity service for the user equipment with the base station;

a device configured to, after the handover of the user equipment is completed, transmit reconfiguration information and an instruction of initiating transmission to the secondary base station so as to re-establish a connection between the base station and the secondary base station, and resuming data transmission of the secondary base station.

According to a further aspect of the present invention, there is provided a dual connectivity system, in which a secondary base station for a user equipment may be changed, wherein the master base station comprises:

a device configured to, if it is determined that a secondary base station that jointly provides a dual connectivity service to the user equipment therewith needs change, transmit a release request to the secondary base station;

a device configured to select one base station to transmit an add request, which add request is for requesting for adding this base station as a secondary base station that jointly provides the dual connectivity service to the user equipment with the master base station;

wherein the secondary base station comprises:

a device configured to transmit a release response to the master base station;

a device configured to transmit its SN status and forward data about the user equipment;

wherein the base station receiving an add request comprises:

a device configured to receive the add response to the master base station, so as to be a new secondary base station of the master base station;

a device configured to receive the SN status and the data, and establish a connection with the user equipment.

Compared with the prior art, the present invention has the following advantages: the present invention provides a handover scheme and a data processing scheme of a user equipment between base stations or cells in the dual connectivity system in various cases.

### BRIEF DESCRIPTION OF THE ACCOMPANYING DRAWINGS

Other features, objectives, and advantages of the present invention will become more apparent through reading the detailed description of the non-limiting embodiments with reference to the accompanying drawings:

FIG. 1 shows a schematic diagram of a relationship among a source base station, a target base station, and a secondary base station according to one preferred embodiment of the present invention;

FIG. 2 shows a flow diagram of a method according to a preferred solution based on the schematic diagram of FIG. 1 of the present invention;

FIG. 3 shows a flow diagram of a method according to a further preferred solution based on the schematic diagram of FIG. 1 of the present invention;

FIG. 4 shows a schematic diagram of a relationship among a source base station, a target base station, and a secondary base station according to one preferred embodiment of the present invention;

FIG. 5 shows a flow diagram of a method according to a preferred solution based on the schematic diagram of FIG. 4 of the present invention;

FIG. 6 shows a flow diagram of a method according to a further preferred solution based on the schematic diagram of FIG. 4 of the present invention;

FIG. 7 shows a schematic diagram of a relationship among a source base station, a target base station, and a secondary base station according to one preferred embodiment of the present invention;

FIG. 8 shows a flow diagram of a method according to a preferred solution based on the schematic diagram of FIG. 7 of the present invention;

FIG. 9 shows a schematic diagram of a relationship among a source base station, a target base station, and a secondary base station according to one preferred embodiment of the present invention;

FIG. 10 shows a flow diagram of a method according to a preferred solution based on the schematic diagram of FIG. 9 of the present invention;

FIG. 11 shows a schematic diagram of a relationship among a source base station, a target base station, and a secondary base station according to one preferred embodiment of the present invention;

FIG. 12 shows a flow diagram of a method according to a preferred solution based on the schematic diagram of FIG. 11 of the present invention;

FIG. 13 shows a schematic diagram of a relationship among a base station and a cell thereunder, and between a base station and a secondary base station according to one preferred embodiment of the present invention;

FIG. 14 shows a schematic diagram of a relationship between a base station and a secondary base station according to one preferred embodiment of the present invention;

FIG. 15 shows a flow diagram of a method according to a preferred solution based on the schematic diagram of FIG. 14 of the present invention;

FIG. 16 shows a flow diagram of a method according to another preferred solution based on the schematic diagram of FIG. 14 of the present invention;

In the accompanying drawings, the same or similar reference numerals represent the same or similar components.

### DETAILED DESCRIPTION OF THE PREFERRED EMBODIMENTS

Adual connectivity system in the present invention comprises a user equipment and at least two base stations connected to the user equipment, which at least two base stations comprise at least one master base station (MeNB) and at least one secondary base station (SeNB). A user plane structure supporting dual connectivity may assume a plurality of manners: for example, assuming the user plane architecture 1A or a user plane architecture 3C, wherein the user plane architecture 1A specifies that one radio bearer is only served by one base station, i.e., a radio bearer cannot be separated and served by a plurality of base stations; the user plane architecture 3C specifies that one radio bearer may be separated and served by a plurality of base stations. Moreover, for the user plane architecture 1A, S1-U terminates at a secondary base station. For a user plane architecture 3C, S1-U terminates in the master base station, and a PDCP (Packet Data Convergence Protocol) PDU (Packet Data Unit) generated by the master base station is forwarded to the secondary base station for transmission.

Hereinafter, the present invention will be described in further detail with reference to the accompanying drawings and a plurality of embodiments.

### Embodiment 1

In this embodiment, the source base station and the target base station of the user equipment during the handover process both support a dual connectivity configuration, i.e., the source base station and the target base station may have secondary base stations jointly providing a dual connectivity service for the user equipment. The present embodiment comprises steps of:

after determining, with a target base station, that the user equipment needs handover, transmitting, by the source base station, connection reconfiguration information to the user equipment, and transmitting a release request to a secondary base station jointly providing the dual connectivity service to the user equipment with the source base station;

transmitting, by the secondary base station of the source base station, a release response to the source base station;

transmitting, by the source base station, an SN status to the target base station, and forwarding data about the user equipment;

receiving, by the target base station, the transmitted SN status and the forwarded data from the source base station, and establishing a connection with the user equipment;

moreover, transmitting, by the target base station, an add request to a base station, which add request is for requesting adding this base station as a secondary base station jointly providing the dual connectivity service to the user equipment with the target base station;

transmitting, by the base station receiving the add request, an add response to the target base station, so as to establish a connection with the user equipment as the secondary base station of the target base station.

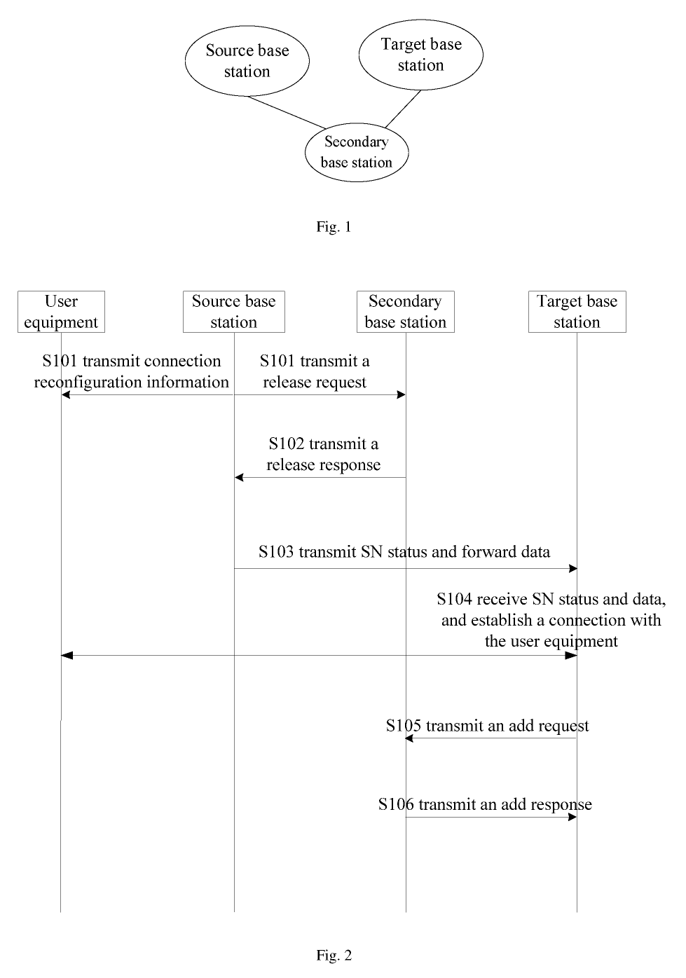

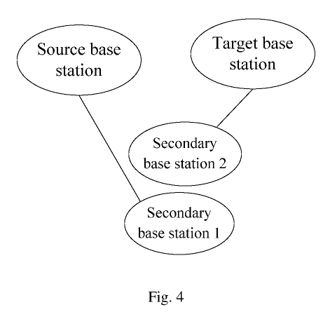

The above method according to the present embodiment may be applied to the scenarios shown in FIGS. 1 and 4.

Hereinafter, the scenario as shown in FIG. 1 will be described.

It is seen from the schematic relationship as shown in FIG. 1 that a secondary base station jointly providing a dual connectivity service for the user equipment with the source base station (hereinafter referred to as the secondary base station of the source base station) before handover of the user equipment, is the same base station as the secondary base station jointly providing a dual connectivity service for the user equipment with the target base station (hereinafter referred to as the secondary base station of the target base station) after the handover of the user equipment to the target base station, wherein determining the secondary base station of the target base station may assume a plurality of manners, which will not be detailed here.

With reference to FIG. 2, FIG. 2 is a flow diagram of a method applied to a preferred solution of the scenario as shown in FIG. 1.

In step S101, after determining, with a target base station, that the user equipment needs handover, the source base station transmits connection reconfiguration information to the user equipment, and transmits a release request to a secondary base station of the source base station. Herein, the connection reconfiguration information may be used to configure a new connection-related parameter for the user equipment such that the user equipment establishes a connection with the target base station; preferably, the connection reconfiguration information may include parameter(s) for the user equipment to establish its connection with the target base station; as an example, the connection reconfiguration information may be RRC connection reconfiguration information (RRCConnectionReconfiguration). Herein, the release request is for requesting for releasing connection(s) between the secondary base station and the user equipment; then, through the release request, the source base station may indicate its secondary base station to release the connection with the user equipment. Herein, the step in which the source base station transmits connection reconfiguration information may be simultaneously performed with the step in which the source base station transmits a release request.

It should be noted that the trigger condition for handover of the user equipment may be various, e.g., location displacement of the user equipment, channel change of the user equipment, etc. Besides, preferably, the process in which the source base station and the target base station determine that the user equipment needs handover may comprise a step in which the source base station performs a user equipment handover decision, a step in which the source base station transmits a handover request to the target base station, a step in which the target base station makes an access decision, and a step in which the target base station transmits a handover request acknowledgement to the source base station, etc.

In step S102, the secondary base station of the source base station transmits a release response to the source base station.

Herein, due to handover of the user equipment, the data and other information about the user equipment in the secondary base station needs corresponding processing. Herein, the operations that may be adopted by the secondary base station of the source base station include, but not limited to:

1) after the secondary base station of the source base station transmits a release response, it transmits its SN (sequence number) status to the source base station and forwards the data about the user equipment; then the source base station transmits the SN status and data of the source base station itself, and the SN status and data transmitted by the secondary base station to the source base station, together to the target base station in the subsequent step S103.

2) after transmitting a release response, the secondary base station transmits its SN status to the target base station and forwards data about the user equipment. In this case, the release request transmitted by the source base station in step S101 includes identification information of the target base station, e.g., the ID of the target base station. The secondary base station may establish a communication with the target base station based on identification information of the target base station, e.g., establishing an Xn interface with the target base station, thereby transmitting the SN status and data.

3) after transmitting a release response, the secondary base station stores its SN status and the data about the user equipment into itself.

The above operation 1) and operation 2) may be performed between step S102 and step S103.

In step S103, the source base station transmits the SN status to the target base station and forwards data about the user equipment.

Herein, if the secondary base station of the source base station does not transmit the SN status and data to the source base station after step S102; then in step S103, the SN status and the forwarded data transmitted by the source base station to the target base station only include the SN status and the data about the user equipment of the source base station itself; if the secondary base station of the source base station transmits the SN status and data to the source base station after step S102, then the SN status and the forwarded data transmitted by the source base station to the target base station comprise the SN status and data of the source base station itself and the SN status and data transmitted from the secondary base station to the source base station.

In step S104, the target base station receives the transmitted SN status and the forwarded data from the source base station, and establishes a connection with the user equipment.

Preferably, the target base station may establish a connection to the user equipment through random access. After the user equipment establishes a connection with the target base station, it may transmit connection reconfiguration complete information (e.g., RRCConnectionReconfigurationComplete) to the target base station. Moreover, after receiving the connection reconfiguration complete information, the target base station may further interact with the MME (Mobility Management Entity) and the S-GW gateway to handover paths, thereby completing handover of the user equipment.

In step S105, the target base station transmits an add request to a base station, which add request is for requesting for adding this base station as a secondary base station that jointly provides a dual connectivity service for the user equipment with the target base station. In the present preferred solution, this base station is the secondary base station of the source base station.

Preferably, the add request may include any information about adding of the secondary base station. Preferably, the add request may include, but not limited to: 1) E-RAB (evolved Radio Access Bearer) feature that includes, but not limited to, E-RAB parameter, and TNL address information corresponding to the user plane option, etc.; 2) UE capabilities; 3) the current radio resource configurations of the user equipment, etc.

In step S106, the base station receiving the add request transmits an add response to the target base station, such that the base station receiving the add request establishes a connection with the user equipment as the secondary base station of the target base station.

Specifically, after receiving the add response, the target base station may transmit connection reconfiguration information to the user equipment, e.g., RRC connection reconfiguration information, such that the secondary base station establishes a connection with the user equipment.

It should be noted that the base station may establish a connection with the user equipment in a random access manner. Preferably, in order to avoid contention, the secondary base station may allocate a dedicated RACH preamble to the user equipment; the add response transmitted by the secondary base station includes the allocated dedicated RACH (Random Access Channel) preamble. Then the connection reconfiguration information transmitted to the user equipment after the target base station receives the add response includes the dedicated RACH preamble, such that the user equipment establishes a connection to the secondary base station of the target base station.

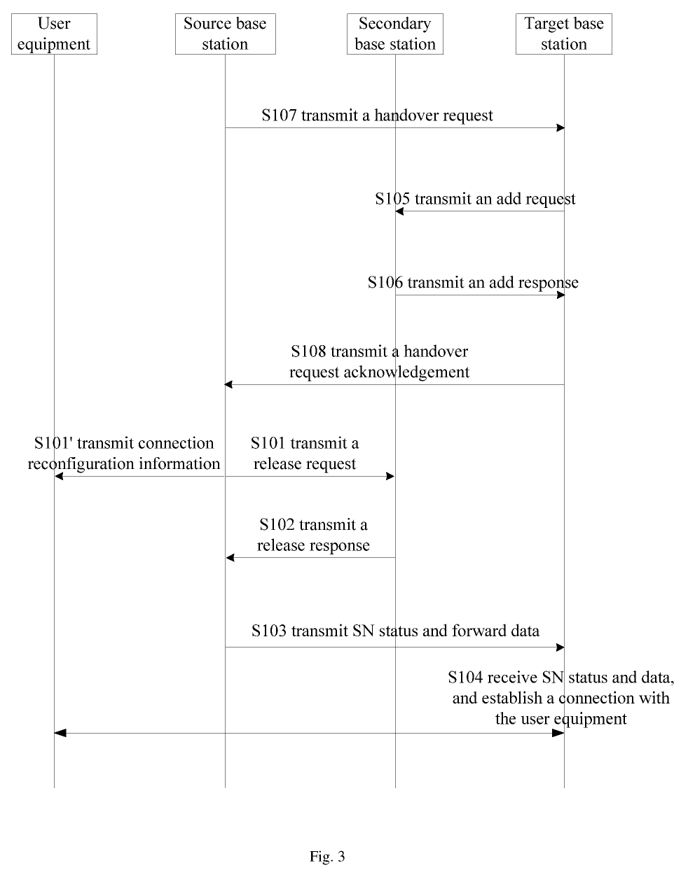

In the present preferred solution, step S105 and step S106 are performed after completion of the handover of the user equipment. However, as another preferred embodiment, step S105 and step S106 may be performed in the process during which the source base station and the target base station determine that the user equipment needs handover, as shown in FIG. 3.

If the source base station makes a decision that the user equipment needs handover, in step S107, the source base station transmits a handover request to the target base station.

The handover request may comprise information about the dual connectivity. For example, a dual connectivity type, e.g., 1A or 3C; for another example, RB (Radio Bearer) type, e.g., the radio bearer served by the master base station, the radio bearer served by the secondary base station, and/or the radio bearer jointly served by the master base station and the secondary base station, etc.; for another example, the dual connectivity configuration information of the RB, etc.

After receiving the handover request, the target base station may perform step S105, and the secondary base station performs step S106; then, in step S108, the target base station may transmit a handover request acknowledgement to the source base station after the wireless resource reconfiguration is completed based on the add response transmitted in step S106.

Preferably, the add response includes a dedicated RACH preamble allocated by the secondary base station for the user equipment. The handover request acknowledgement transmitted in step S108 includes the dedicated RACH preamble. Then, in step S101′, the connection reconfiguration information transmitted by the source base station includes the dedicated RACH preamble, such that the user equipment establishes a connection with the secondary base station of the target base station.

Next, steps S102, S103, and S104 have been illustrated in the present preferred solution shown in FIG. 2, which will not be detailed here.

It should be noted that when the handover of the user equipment is completed, the target base station may transmit a reconfiguration request to update the dual connectivity configuration, so as to adjust the E-RAB service. Because the load condition and the channel quality of the source base station and the target base station are different, the previous dual connectivity configuration may not be necessarily effectively used by the new dual connectivity link after handover. Therefore, a new adjustment may be performed when the master base station changes.

It should be noted that in the present preferred solution, release of the secondary base station occurs before adding of the secondary base station. Therefore, if the current dual connectivity configuration limits that one radio bearer is only served by one base station, as specified in 1A; then, after transmitting the release response, the secondary base station may store its SN status and the data about the user equipment into itself; besides, once the connection of the secondary base station to the target base station and the user equipment is reestablished, the secondary base station may continue transmitting data to the user equipment. However, if the current dual connectivity configuration limits that one radio bearer may be served by a plurality of base stations, as specified in 3C, because the PDCP layer is in the master base station and the master base station changes from the source base station to the target base station, the PDCP layer needs to be reset and the key also needs to change. Therefore, for the PDCP PDU that is buffered in the master base station and the secondary base station and is not transmitted yet, it needs to be recreated based on the new key. In the present preferred solution, the data forwarding from the secondary base station to the master base station may not be performed; however, the SN status may be notified to the target base station, such that the target base station is clear about the PDCP PDU that need to be transmitted and recreated.

It should be noted that if the step S105 and step S106 are performed before the target base station transmits a handover request acknowledgement, the step S105 and the step S106 will go through the Xn interface and delay the step of transmitting the handover request acknowledgement. Therefore, the solution of performing the step S105 and the step S106 before the target base station transmits the handover request acknowledgement is more suitable for the scenario in which the transmission delay of the Xn interface between the source base station and the target base station and between the master base station and the secondary base station is smaller, e.g., the delay is 2-5 ms. And, the solution of performing steps S105 and S106 after the completing of handover of user equipment is more suitable for the scenario in which the transmission delay of the Xn interface between the source base station and the target base station and between the master base station and the secondary base station is relatively large.

Hereinafter, the scenario shown in FIG. 4 will be illustrated.

It is seen from the schematic relationship as shown in FIG. 4 that the secondary base station of the source base station and the secondary base station of the target base station are different.

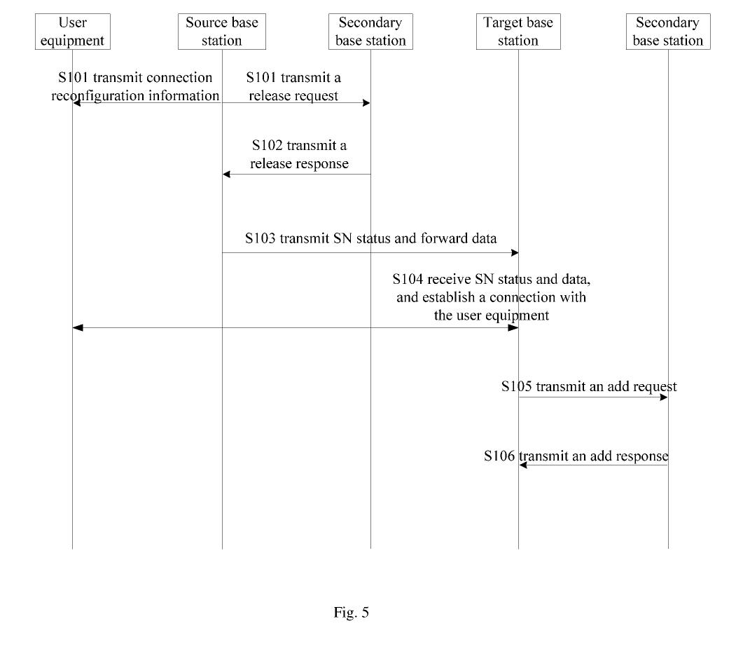

Please refer to FIG. 5. FIG. 5 shows a flow diagram of a method applied to a preferred solution of the scenario as shown in FIG. 4. Herein, step S101, step S102, step S103, step S104, step S105, and step S106 are all identical or similar to the corresponding steps in the preferred solution of FIG. 2.

The present preferred solution differs from the preferred solution shown in FIG. 2 mainly in that, in the preferred solution as shown in FIG. 2, the secondary base station 1 of the source base station may store the SN status and the data about the user equipment in itself, or transmit to the target base station directly or via the source base station. However, in the present preferred solution, if the radio bearer(s) served by the secondary base station 1 of the source base station is identical to the radio bearer served by the secondary base station 2 of the target base station, then the secondary base station 1 of the source base station transmits the SN status to the secondary base station 2 of the target base station and forwards data about the user equipment; if the radio bearer(s) served by the secondary base station 1 of the source base station and the radio bearer served by the secondary base station 2 of the target base station are different, then the secondary base station 1 of the source base station transmits the SN status to the target base station and forwards data about the user equipment.

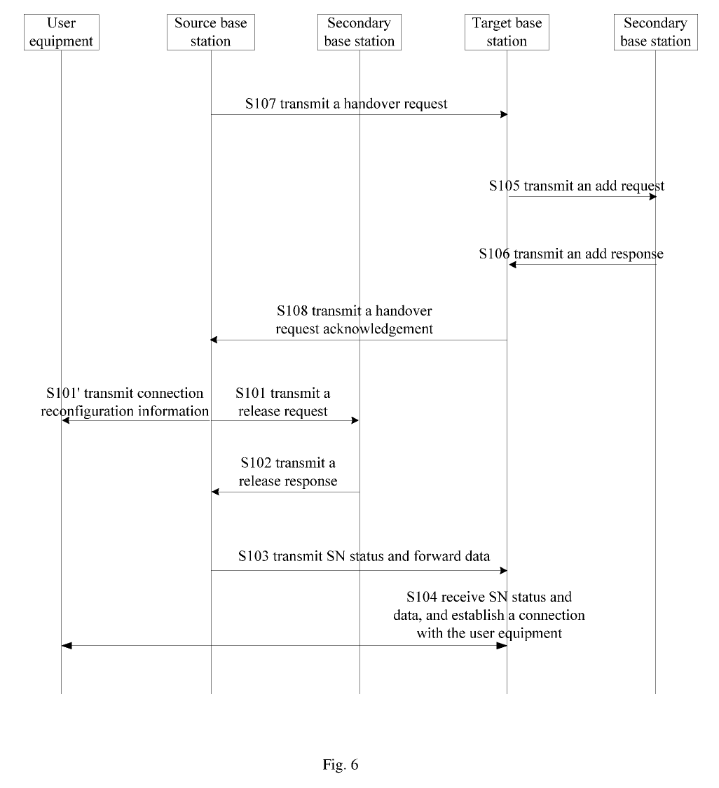

Refer to FIG. 6, in which a flow diagram of a method according to a further preferred solution applied to the scenario as shown in FIG. 4. Herein, steps S101′, S102, S103, S104, S105, S106, S107, and S108 are all identical or similar to the corresponding steps in the preferred solution as shown in FIG. 3.

The present preferred solution differs from the preferred solution shown with reference to FIG. 3 mainly in that, in the preferred solution as shown in FIG. 3, a secondary base station 1 of the source base station may store the SN status and the data about the user equipment in itself. However, in the present preferred solution, if the radio bearer(s) served by the secondary base station 1 of the source base station and the radio bearer(s) served by the secondary base station 2 of the target base station are identical, then the secondary base station 1 of the source base station transmits the SN status to the secondary base station 2 of the target base station and forwards data about the user equipment; if the radio bearer(s) served by the secondary base station 1 of the source base station and the radio bearer(s) served by the secondary base station 2 of the target base station are different, the secondary base station 1 of the source base station transmits the SN status to the target base station and forwards data about the user equipment.

### Embodiment 2

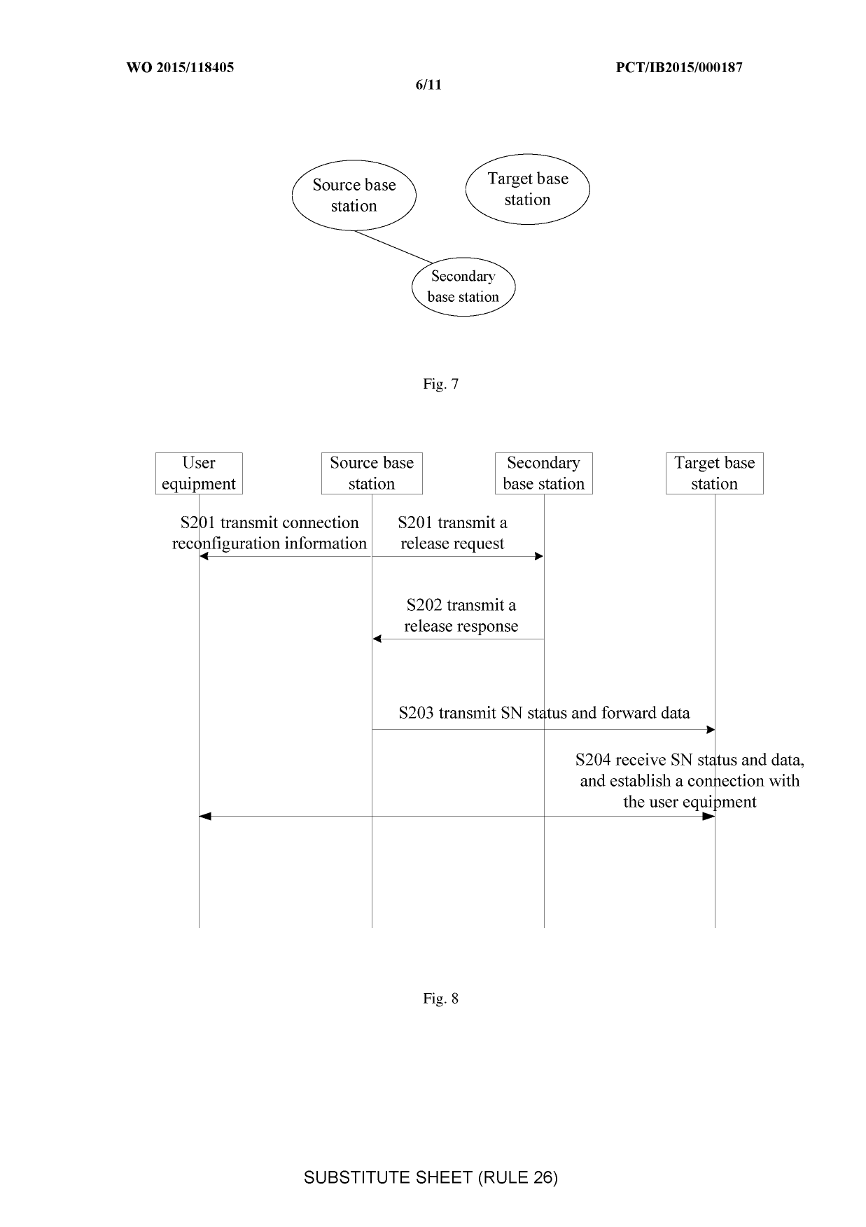

In this embodiment, the source base station of the user equipment during the handover process supports a dual connectivity configuration, and the target base station of the user equipment during the handover process does not support the dual connectivity configuration, as shown in FIG. 7. In other words, the source base station may have a secondary base station jointly providing dual connectivity service for the user equipment, while the target base station does not have a secondary base station jointly providing dual connectivity service for the user equipment. For the steps of this embodiment, please refer to FIG. 8.

In step S201, after determines that the user equipment needs handover with the target base station, the source base station transmits connection reconfiguration information to the user equipment, and transmits a release request to the secondary base station jointly providing dual connectivity service to the user equipment with the source base station, wherein the process in which the source base station and the target base station determines that the user equipment needs handover comprises a step of transmitting, by the source base station, a handover request to the target base station, and a step of transmitting, by the target base station, a handover request acknowledgement to the source base station.

Herein, if the source base station does not sure whether the target base station supports dual connectivity configuration or not, the source base station includes information related to the dual connectivity in the handover request. For example, a dual connectivity type, e.g., 1A or 3C; for another example, the RB (radio bearer) type, such as the radio bearer served by the master base station, the radio bearer served by the secondary base station, and/or the radio bearer jointly served by the master base station and the secondary base station, etc.; for another example, the dual connectivity configuration information of the RB, etc. If the source base station has pre-determined that the target base station does not support dual connectivity configuration, during the process in which the source base station and the target base station determine that the user equipment needs handover, the source base station will not include the information related to the dual connectivity in the handover request.

Or, the source base station transmits the current cell configuration to the target base station in the handover request, then the target base station configures the user equipment to a single connectivity, and notifies the configuration of the single connectivity to the user equipment through the connection reconfiguration information transmitted by the source base station. Then, after the user equipment configures itself as a single connection based on the connection reconfiguration information, the secondary base station is automatically released.

In step S202, the secondary base station of the source base station transmits a release response to the source base station, and transmits its SN status and forwards data about the user equipment to the source base station or the target base station.

In step S203, the source base station transmits the SN status to the target base station and forwards data about the user equipment; the SN status and data transmitted by the source base station include the SN status and data of the source base station itself, or include the SN status and data of the source base station itself and the SN status and data transmitted by the secondary base station to the source base station.

Herein, if in step S202, the secondary base station transmits its SN status and forward the data about the user equipment to the source base station, then in step S203, the SN status and data transmitted by the source base station include the SN status and data of the source base station itself and the SN status and data transmitted by the secondary base station to the source base station; if in step S202, the secondary base station transmits its SN status to the target base station and forwards data about the user equipment; then in step S203, the SN status and data transmitted by the source base station include the SN status and data of the source base station itself.

In step S204, the target base station receives the SN status and the forwarded data transmitted by the source base station, or receives the SN status and the forwarded data transmitted by the source base station and the secondary base station, and establishes a connection with the user equipment.

Herein, if in step S202, the secondary base station transmits its SN status to the source base station and forwards data about the user equipment, then in step S204, the target base station receives the SN status and the forwarded data transmitted by the source base station; if in step S202, the secondary base station transmits its SN status to the target base station and forwards data about the user equipment, then in step S204, the target base station receives the SN status and the forwarded data transmitted by the source base station and the secondary base station.

### Embodiment 3

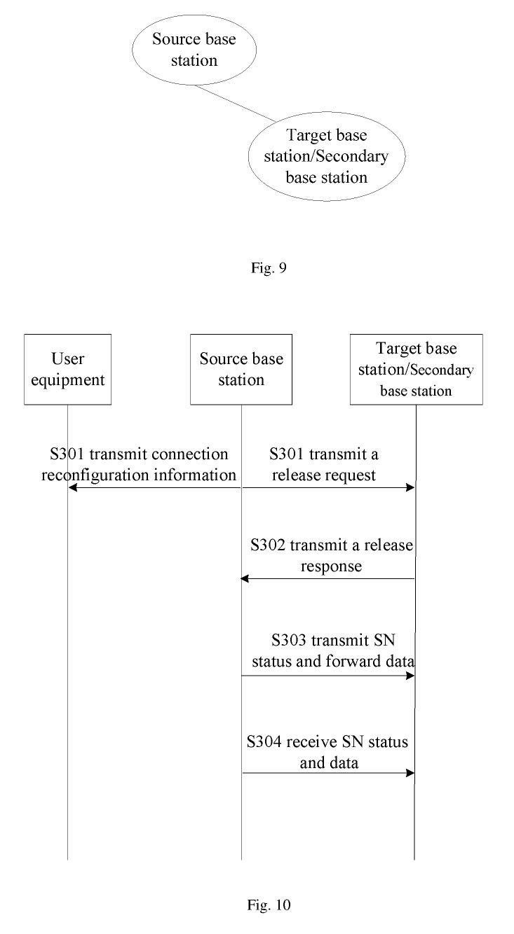

In this embodiment, the source base station of the user equipment during the handover process supports a dual connectivity configuration, i.e., the source base station may have a secondary base station jointly providing a dual connectivity service to the user equipment, and the secondary base station of the source base station and the target base station are the same base station, as shown in FIG. 9. Steps of this embodiment are illustrated in FIG. 10.

In step S301, after determining, with the target base station, that the user equipment needs handover, the source base station transmits connection reconfiguration information to the user equipment, and transmits a release request to the secondary base station (i.e., target base station), which release request is for requesting for releasing the connection between the secondary base station and the user equipment.

In step S302, the secondary base station transmits a release response to the source base station, and stores its SN status and the data about the user equipment into itself.

In step S303, the source base station transmits the SN status to the target base station, and forwards data about the user equipment.

Preferably, the manner in which the source base station forwards data about the user equipment to the target base station includes, but not limited to:

1) for a radio bearer completely served by the source base station, e.g., radio bearer of 1A type, the source base station forwards the transmitted SN status and all data about the user equipment on the radio bearer to the target base station.

2) for radio bearer jointly served by the source base station and the target base station, e.g., a radio bearer of 3C type, the source base station forwards the transmitted SN status and the data about the user equipment served by the source base station on the radio bearer to the target base station.

In step S304, the target base station receives the transmitted SN status and the forwarded data from the source base station.

It should be noted that because the target base station has already been connected to the user equipment as the secondary base station, in this embodiment, the target base station needn't perform the step of establishing a connection with the user equipment through random access.

Preferably, after configuration is completed based on the connection reconfiguration information transmitted by the source base station, the user equipment may transmit connection reconfiguration complete information to the target base station, e.g., RRCConnectionReconfigurationComplete. Moreover, after receiving the connection reconfiguration complete information, the target base station may further handover path(s) through interaction with MME and S-GW, thereby completing handover of the user equipment.

### Embodiment 4

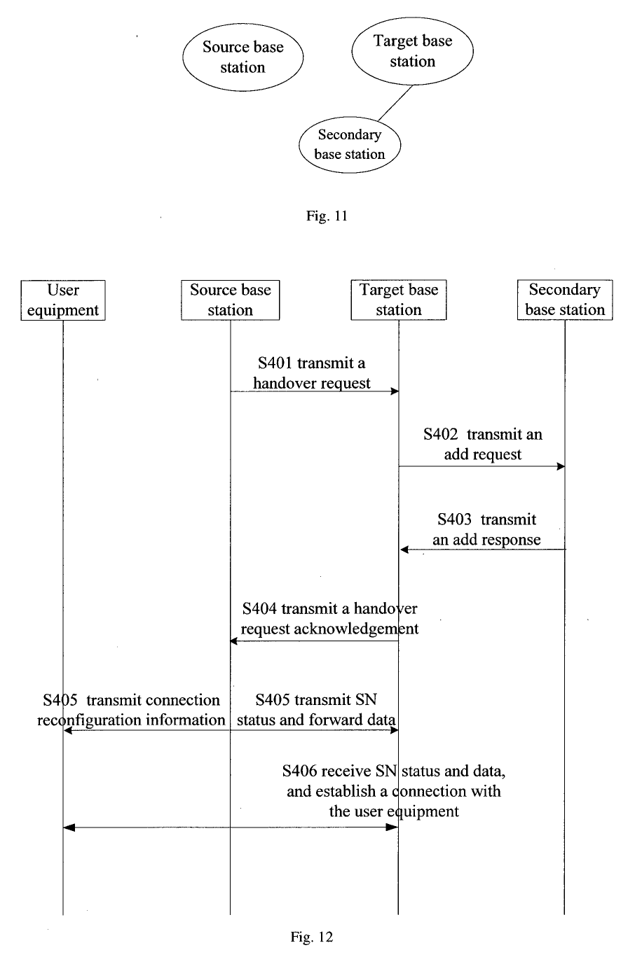

In the present embodiment, the target base station of the user equipment during the handover process supports a dual connectivity configuration, which source base station does not support the dual connectivity configuration. In other words, the target base station may have a secondary base station jointly providing a dual connectivity service to the user equipment, while the source base station does not have a secondary base station jointly providing a dual connectivity service for the user equipment, as shown in FIG. 11.

Refer to FIG. 12. FIG. 12 shows a flow diagram of a method applied to a preferred solution of the scenario as shown in FIG. 11.

If the source base station makes a decision of handing over the user equipment, in step S401, the source base station transmits a handover request to the target base station.

If the target base station makes an access decision, in step S402, the target base station transmits an add request to a base station, which add request is for requesting for adding this base station as a secondary base station that jointly provides, with the target base station, the dual connectivity service to the user equipment.

Preferably, the add request may include any information related to addition of a secondary base station. Preferably, the add request may include, but not limited to: 1) E-RAB feature that includes, but not limited to, an E-RAB parameter, TNL address information corresponding to the user plane option, etc; 2) UE capabilities; 3) the current radio resource configuration of the user equipment, etc.

In step S403, the base station receiving the add request transmits an add response to the target base station, such that the base station receiving the add request establishes a connection with the user equipment as the secondary base station of the target base station.

Preferably, after receiving the add request, if the RRM in the secondary base station makes a decision of allowing an add request, the RRM of the secondary base station configures radio resources, and determines the radio resources based on the user plane option, e.g., 1A or 3C. The secondary base station may include its new radio resource configuration in the add response, e.g., for user plane architecture 1A, the new radio resource configuration may include S1 downlink TNL (Transport Network Layer) address information of respective E-RAB according to the actual conditions; for user plane architecture 3C, the new wireless resource configuration may include X2 and downlink TNL address information, etc.

Preferably, in order to avoid contention, the secondary base station may allocate a dedicated RACH preamble for the user equipment, and the add response transmitted by the secondary base station includes the dedicated RACH preamble.

In step S404, the target base station transmits a handover request acknowledgement to the source base station.

Preferably, the target base station performs reconfiguration of the wireless resources based on the add response, and transmits the handover request acknowledgement.

Preferably, if the add response comprises a dedicated RACH preamble, the handover request acknowledgement may also comprise the dedicated RACH preamble.

In step S405, the source base station transmits the SN status to the target base station and forwards data about the user equipment, and transmits connection reconfiguration information to the user equipment.

Preferably, if the handover request acknowledgement transmitted by the target base station includes a dedicated RACH preamble, then the connection reconfiguration information transmitted by the source base station may also comprise the dedicated RACH preamble, such that the user equipment establishes a connection to the secondary base station of the target base station.

In step S406, the target base station receives the transmitted SN status and the forwarded data from the source base station, and establishes connection with the user equipment.

It should be noted that the target base station will transmit a part of the SN status and data provided by the source base station to the secondary base station, so as to be capable of providing a dual connectivity service to the user equipment jointly with the secondary base station.

In the above preferred solution, steps S402 and S403 are performed between step S401 and step S404. This preferred solution is more suitable for the scenario in which the Xn interface delay between the source base station and the target base station and between the master base station and the secondary base station is relatively short.

As a further preferred solution of the present embodiment, the present preferred solution mainly differs from the previous preferred solution in that, steps S402 and S403 in the present preferred solution may be performed after step S404; preferably, steps S402 and S403 may be performed between the step S404 and the step of transmitting, by the source base station, connection reconfiguration information. The present preferred solution may be adapted to the scenario in which the Xn interface delay between the source base station and the target base station and between the master base station and the secondary base station is relatively long.

It should be noted that in the present solution, the add response transmitted by the secondary base station includes the dedicated RACH preamble allocated by the secondary base station of the target base station for the user equipment. The target base station may transmit the connection reconfiguration information to the user equipment after the user equipment completes reconfiguration based on the connection reconfiguration information transmitted by the source base station and transmits the connection reconfiguration complete information to the target base station, which connection reconfiguration information transmitted by the target base station includes the dedicated RACH preamble, such that the user equipment establishes the connection with the secondary base station of the target base station.

### Embodiment 5

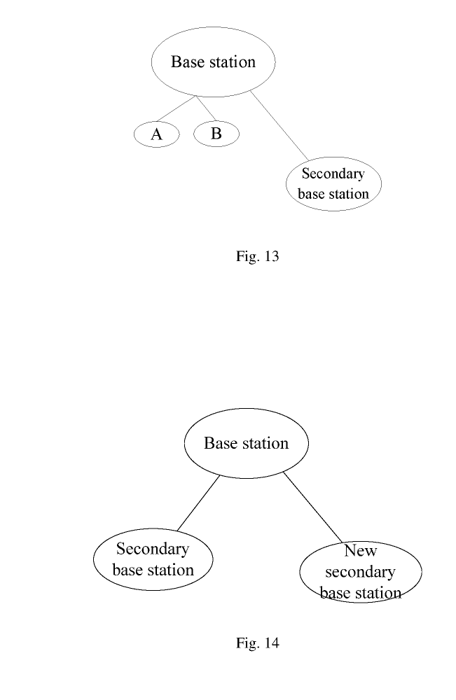

In the present embodiment, the user equipment has a handover from one cell to a further cell under one base station in the dual connection system, wherein the base station supports dual connectivity configuration, as shown in FIG. 13.

A preferred solution of the present embodiment comprises the following steps:

If it is determined that the user equipment needs to handover from one cell A of the base station to a further cell B, the base station transmits a release request to the secondary base station jointly providing the dual connectivity service to the user equipment with the base station; this step may be performed simultaneously with the step of transmitting connection reconfiguration information to the user equipment.

Next, the secondary base station transmits a release response to the base station;

Next, after the handover of the user equipment is completed, the base station transmits an add request to the secondary base station;

Next, the secondary base station transmits an add response to the base station, thereby reestablishing its connection with the base station.

Preferably, after receiving the release request, the secondary base station transmits the SN status to the base station and forwards data about the user equipment; besides, after reconnection to the base station, the secondary base station obtains SN status and data from the base station. This manner is closer to the existing standard and is easier to be implemented.

Or, preferably, the secondary base station may save the SN status and the data about the user equipment in itself, and after reestablishing a connection with the base station, continues to serve the user equipment based on the saved data. It should be noted that because the key of the secondary base station will change after reestablishing the connection, it is necessary to re-form the PDCP PDU for the saved SN status and data based on the new key. However, for a part of user plane architectures, e.g., 3C, because it is impossible to re-form the PDCP PDU based on the new key, the manner of saving the SN status and the data about the user equipment in itself cannot be adapted to the dual connectivity configuration with such user plane architecture.

Another preferred solution of the present embodiment comprises steps of:

If it is determined that the user equipment needs to handover from one cell of the base station to a further base station, the base station transmits an instruction of stopping transmission to the secondary base station that jointly provides a dual connectivity service for the user equipment with the base station.

Next, after the handover of the user equipment is completed, the base station transmits reconfiguration information and an instruction of initiating transmission to the secondary base station, and resumes data transmission of the secondary base station.

The present solution is more rapid and effective.

### Embodiment 6

In the present embodiment, the secondary base station of the user equipment changes, as shown in FIG. 14. The present embodiment comprises steps of:

If a master base station determines that a secondary base station that jointly provides a dual connectivity service to the user equipment therewith needs change, transmitting a release request to the secondary base station.

The secondary base station transmits a release response to the master base station.

The secondary base station transmits its SN status and forwarding data about the user equipment. Wherein the secondary base station may transmit its SN status and forwards data about the user equipment to the master base station or a new secondary base station. The specific manner will be described in detail hereinafter.

The master base station selects one base station to send an add request, which add request is for requesting for adding this base station as a secondary base station that jointly provides the dual connectivity service to the user equipment with the master base station.

The base station receiving the add request transmits an add response to the master base station, so as to act as a new secondary base station of the master base station.

The new secondary base station receives the SN status and data, and establishes connection with the user equipment, wherein the new secondary base station may receive the SN status and data from the master base station or the original secondary base station. The specific manner will be described in detail hereinafter.

The master base station forwards the release acknowledgment information of the secondary base station transmitted by the user equipment to the secondary base station, and forwards the add acknowledgement information of the new secondary base station transmitted by the user equipment to the new secondary base station.

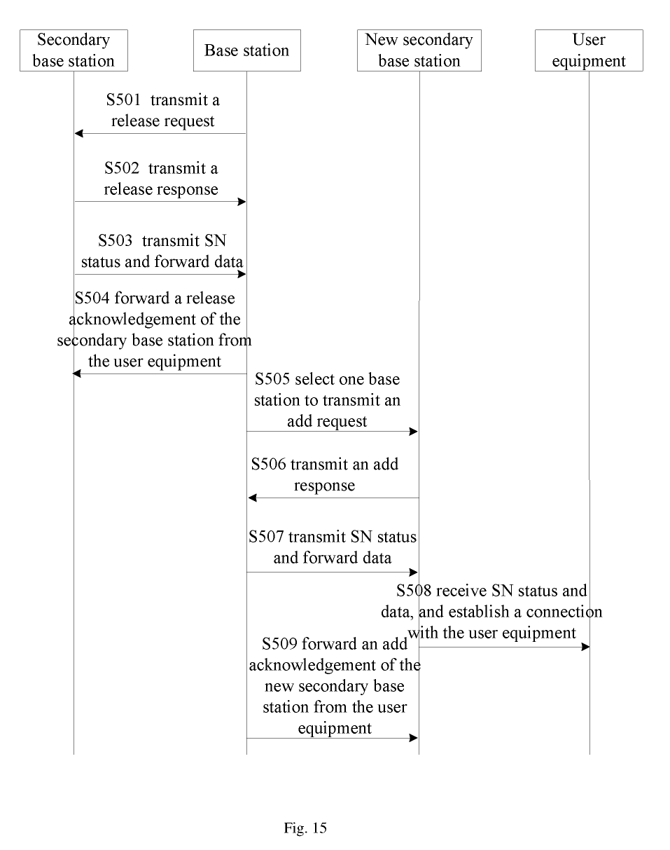

Refer to FIG. 15, in which a flow diagram of a method based on a preferred solution of the present embodiment is presented.

In step S501, if the master base station determines that a secondary base station that jointly provides a dual-connectivity service to the user equipment therewith needs change, transmit a release request to the secondary base station.

Wherein, the change may be triggered by the master base station or the secondary base station. Preferably, change of the secondary base station is incurred by change of a secondary cell(SPcell) providing a dual connectivity service to the user equipment under the secondary base station. For example, the secondary cell providing a dual connectivity service for the user equipment under the secondary base station is changed to be overloaded or in a bad wireless state, etc., and other cells under the secondary base station cannot provide a relatively good dual connectivity service for the user equipment; then the master base station determines that it is necessary to select a cell under other base station than the present secondary base station as the secondary base station, thereby triggering change of the secondary base station, etc. Herein, the secondary cell may have a part of functions of a primary cell(Pcell) providing services to the user equipment under the master base station, e.g., for RAR message, uplink control channel transmission of uplink of all PRACH (Physical Random Access Channel) on the secondary base station, etc.

In step S502, the secondary base station transmits a release response to the master base station.

It should be noted that after receiving the release response transmitted by the secondary base station after step S502, the master base station may transmit connection reconfiguration information to the user equipment, e.g., RRC connection reconfiguration information, to reconfigure the user equipment, so as to release its connection with the secondary base station. After successful configuration based on the connection reconfiguration information, the user equipment transmits connection reconfiguration complete information to the master base station as the release acknowledgement information of the secondary base station, so as to notify the base station that it has been successfully reconfigured and release the original secondary base station. The master base station may receive the release acknowledgement information of the secondary base station transmitted by the user equipment between step S502 and step S504.

In step S503, the secondary base station transmits its SN status and forwards data about the user equipment after transmitting the release response.

Specifically, in the present preferred solution, the secondary base station transmits the SN status to the master base station and performs data forwarding.

In step S504, the master base station forwards the release acknowledgement information of the secondary base station transmitted by the user equipment to the secondary base station. Then, the original secondary base station can acknowledge that the user equipment has released its connection thereto.

In step S505, the master base station selects one base station to transmit an add request, which add request is for requesting for adding this base station as a secondary base station that jointly provides the dual connectivity service to the user equipment with the master base station.

In step S506, the base station receiving the add request transmits an add response to the master base station, so as to act as a new secondary base station of the master base station.

In step S507, after receiving the add response, the master base station transmits, to the new secondary base station, the SN status and the data received from the original secondary base station.

Preferably, after receiving the add response, the master base station further transmits connection reconfiguration information to the user equipment so as to indicate the user equipment to establish a connection to the new secondary base station.

In step S508, the new secondary base station receives the SN status and data, and establishes a connection to the user equipment.

The user equipment may transmit add acknowledgement information of the new secondary base station to the master base station, then in step S509, the master base station forwards the add acknowledgement information of the new secondary base station transmitted by the user equipment to the new secondary base station.

Specifically, in the present preferred solution, the new secondary base station receives the SN status and the data provided by the master base station.

It is seen from the above step that the present preferred solution comprises twice of data forwarding, i.e., forwarding data from the original secondary base station to the master base station, and forwarding data from the master base station to the new secondary base station.

It should be noted that the present preferred solution may have one or twice of path handover.

Hereinafter, a solution of presence of twice path handover will be illustrated.

After receiving release acknowledgement information of the secondary base station transmitted by the user equipment thereto after step S502, the master base station performs a first path handover, i.e., handing over the path via the original secondary base station to a path via the master base station; wherein the master base station may transmit the connection reconfiguration complete information to the original secondary base station. The first path handover may be performed before step S505.

After the new secondary base station establishes a connection with the user equipment, the master base station performs a second path handover, i.e., handing over a part of path via the master base station to the path via the new secondary base station.

A solution of presence of one path handover will be explained.

After the master base station receives the release acknowledgement information of the secondary base station transmitted by the user equipment thereto after step S502, the master base station maintains the original path, without performing path handover, and the master base station only performs one path handover till a connection is established between the new secondary base station and the user equipment, so as to handover the path via the original secondary to the path via the new secondary base station.

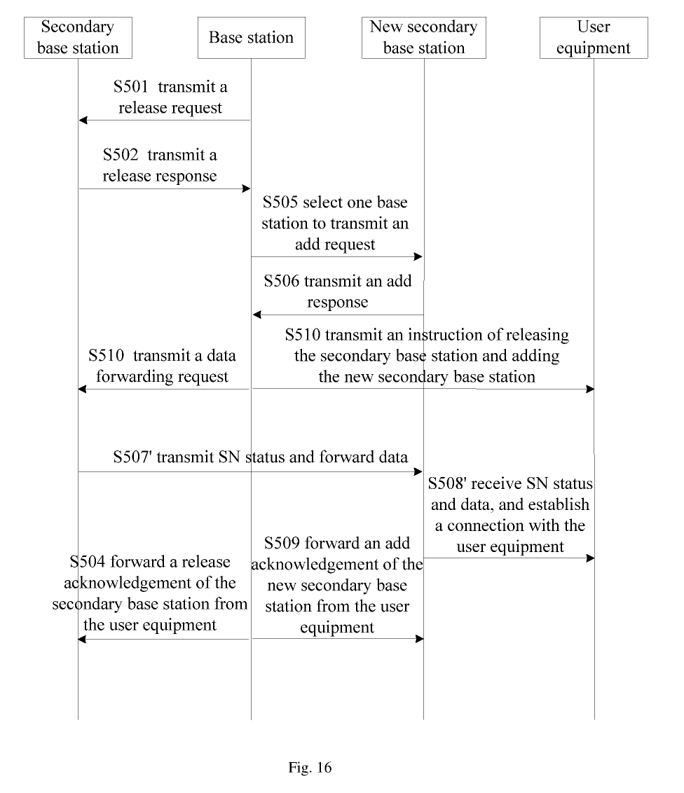

Refer to FIG. 16, in which a flow diagram of a method based on another preferred solution of the present embodiment is presented.

In step S501, if the master base station determines that a secondary base station that jointly provides a dual connectivity service to the user equipment therewith needs change, transmits a release request to the secondary base station.

In step S502, the secondary base station transmits a release response to the master base station.

In the present preferred solution, after step S502, the secondary base station does not perform the step S503. The master base station directly performs the following step S504.

In step S505, the master base station selects one base station to transmit an add request, which add request is for requesting for adding the base station as a secondary base station that jointly provides the dual connectivity service to the user equipment with the master base station.

In step S506, the base station receiving the add request transmits an add response to the master base station, so as to act as a new secondary base station of the master base station.

Next, in step S510, after receiving the add response, the master base station transmits a data forwarding request to the secondary base station, and transmits, to the user equipment, instructions of releasing the secondary base station and adding the new secondary base station.

Herein, the instructions of releasing the secondary base station and adding the new secondary base station may be implemented through connection reconfiguration information.

In step S507′, after receiving the data forwarding request, the secondary base station transmits its SN status and forwards data about the user equipment.

Specifically, in the present preferred solution, the secondary base station transmits its SN status to the new secondary base station and forwards data about the user equipment. Preferably, the secondary base station may transmits SN status and data to the new secondary base station through a temporary interface between itself and the new secondary base station, e.g., a temporary Xn interface, to transmit the SN status and data to the new secondary base station. The temporary interface may be released after the SN status and data are completely transmitted.

In step S508′, the new secondary base station receives the SN status and data, and establishes connection with the user equipment.

Specifically, in the present preferred solution, the new secondary base station directly receives the SN status and data provided by the secondary base station.

Step S504 and step S509 of the present preferred solution may be simultaneously performed, i.e., a step in which the master base station forwards the release acknowledgement information of the secondary base station transmitted by the user equipment to the secondary base station, and the step of forwarding the add acknowledgement information of the new secondary base station transmitted by the user equipment to the new secondary base station, may be performed simultaneously.

It is seen from the above steps that the present preferred solution only comprises once data forwarding, i.e., data forwarding from the original secondary base station to the new secondary base station.

It should be noted that the present preferred solution may also only present once path handing over. Specifically, the present preferred solution may perform path handing over after the new secondary base station establishes a connection to the user equipment, i.e., handing over the path via the original secondary base station to the path via the new secondary base station.

The present preferred solution may reduce the times of data forwarding and path handing over, thereby reducing signaling overheads.

It should be noted that based on the actual condition with the user equipment, one base station in the dual connectivity system may act as any one of the source base station, target base station, and secondary base station; wherein the source base station and the target base station are master base stations during the user equipment handover process.

The base station of the present invention may comprise various devices, which various devices can carry out different steps and/or functions of the present invention. It should be noted that the present disclosure may be implemented in software or a combination of software and hardware; for example, it may be implemented by a dedicated integrated circuit (ASIC), a general-purpose computer, or any other similar hardware device. In an embodiment, the software program of the present disclosure may be executed by a processor so as to implement the above steps or functions. Likewise, the software program of the present disclosure (including relevant data structure) may be stored in a computer readable recording medium, for example, a RAM memory, a magnetic or optical driver, or a floppy disk, and similar devices. Besides, some steps of functions of the present disclosure may be implemented by hardware, for example, a circuit cooperating with the processor to execute various functions or steps.

To those skilled in the art, it is apparent that the present disclosure is not limited to the details of the above exemplary embodiments, and the present disclosure may be implemented with other forms without departing from the spirit or basic features of the present disclosure. Thus, in any way, the embodiments should be regarded as exemplary, not limitative; the scope of the present disclosure is limited by the appended claims, instead of the above depiction. Thus, all variations intended to fall into the meaning and scope of equivalent elements of the claims should be covered within the present disclosure. No reference signs in the claims should be regarded as limiting the involved claims. Besides, it is apparent that the term “comprise/comprising/include/including” does not exclude other units or steps, and singularity does not exclude plurality. A plurality of units or means stated in the apparatus claims may also be implemented by a single unit or means through software or hardware. Terms such as the first and the second are used to indicate names, but do not indicate any particular sequence.

1. A method for handing over a user equipment to a target base station from a source base station in a dual connectivity system, wherein both of the source base station and the target base station support a dual connectivity configuration, the method comprising:
after determining, with a target base station, that the user equipment needs handover, transmitting, by the source base station, connection reconfiguration information to the user equipment, and transmitting a release request to a secondary base station jointly providing the dual connectivity service to the user equipment with the source base station;
transmitting, by the secondary base station of the source base station, a release response to the source base station;
transmitting, by the source base station, an SN status to the target base station, and forwarding data about the user equipment;
receiving, by the target base station, the transmitted SN status and the forwarded data from the source base station, and establishing a connection with the user equipment;
wherein the method further comprises:
transmitting, by the target base station, an add request to a base station, which add request is for requesting adding this base station as a secondary base station jointly providing the dual connectivity service to the user equipment with the target base station;
transmitting, by the base station receiving the add request, an add response to the target base station, so as to establish a connection with the user equipment as the secondary base station of the target base station.

2.-4. (canceled)

5. The method according to claim 1, wherein the add response includes a dedicated RACH preamble allocated by the secondary base station of the target base station for the user equipment, the process of determining that the user equipment needs handover comprises a transmitting, by the target base station, a handover request acknowledgement to the source base station, which handover request acknowledgement includes the dedicated RACH preamble, and the connection reconfiguration information transmitted by the source base station includes the dedicated RACH preamble, such that the user equipment establishes a connection to the secondary base station of the target base station.

6.-7. (canceled)

8. A method for handing over a user equipment from a source base station to a target base station in a dual connectivity system, wherein the source base station supports dual-connectivity configuration, the target base station does not support a dual-connectivity configuration, the method comprising:
after determining, with the target base station, that the user equipment needs handover, transmitting, by the source base station, connection reconfiguration information to the user equipment, and transmitting a release request to a secondary base station jointly providing the dual connectivity service for the user equipment with the source base station;
transmitting, by the secondary base station of the source base station, a release response to the source base station, and transmitting its SN status and forwarding data about the user equipment to the source base station or the target base station;
transmitting, by the source base station, the SN status and forwarding data about the user equipment to the target base station, which SN status and data include the SN status and data of the source base station itself, or include the SN status and data of the source base station itself and the SN status and data transmitted from the secondary base station to the source base station;
receiving, by the target base station, the transmitted SN status and the forwarded data from the source base station, or from the source base station and the secondary base station, and establishing a connection with the user equipment.

9. A method of handing over a user equipment from a source base station to a target base station in a dual connectivity system, wherein the source base station supports a dual connectivity configuration, the secondary base station jointly providing service to the user equipment with the source base station under the dual connectivity configuration is the same base station as the target base station, the method comprising:
after determining, with the target base station, that the user equipment needs handover, transmitting, by the source base station, connection reconfiguration information to the user equipment, and transmitting a release request to the secondary base station, which release request is for requesting the secondary base station to release its connection with the user equipment;
transmitting, by the secondary base station, a release response to the source base station, and storing its SN status and the data about the user equipment into itself;
transmitting, by the source base station, the SN status to the target base station, and forwarding data about the user equipment;
receiving, by the target base station, the transmitted SN status and the forwarded data from the source base station, and establishing a connection with the user equipment.

10. (canceled)

11. A method for handing over a user equipment from a source base station to a target base station in a dual connectivity system, wherein the target base station supports a dual connectivity configuration, which source base station does not support the dual-connectivity configuration, the method comprising:
transmitting, by the source base station, a handover request to the target base station;
transmitting, by the target base station, a handover request acknowledgement to the source base station;
transmitting, by the source base station, SN status to the target base station, and forwarding data about the user equipment, and transmitting connection reconfiguration information to the user equipment;
receiving, by the target base station, the transmitted SN status and the forwarded data from the source base station, and establishing a connection with the user equipment;
wherein the method further comprises:
transmitting, by the target base station, an add request to a base station, which add request is for requesting for adding this base station as a secondary base station that jointly provides, with the target base station, the dual connectivity service to the user equipment;
transmitting, by the base station receiving the add request, an add response to the target base station, so as to establish a connection with the user equipment as the secondary base station of the target base station.

12.-15.

16. A method of handing over a user equipment from one cell to a further cell in a dual connectivity system, wherein the cell and the further cell belong to the same base station, and the base station supports dual connectivity configuration, the method comprising:
transmitting, by the base station, a release request to the secondary base station jointly providing the dual connectivity service to the user equipment with the base station, if it is determined that the user equipment needs to handover from one cell of the base station to the further cell;
transmitting, by the secondary base station, a release response to the base station;
transmitting, by the base station, an add request to the secondary base station after the handover of the user equipment is completed;
transmitting, by the secondary base station, an add response to the base station, thereby reestablishing its connection with the base station.

17. (canceled)

18. A method for handing over a user equipment from one cell to a further cell, wherein the cell and the further cell belong to the same base station, and the base station supports a dual-connectivity configuration, the method comprising:
transmitting, by the base station, an instruction of stopping transmission to a secondary base station jointly providing a dual connectivity service for the user equipment with the base station, if it is determined that the user equipment needs to handover from one cell to a further cell of the base station;
transmitting, by the base station, reconfiguration information and an instruction of initiating transmission to the secondary base station so as to reestablish the connection between the base station and the secondary base station, and resuming data transmission of the secondary base station, after the handover of the user equipment is completed.

19. A method for changing a secondary base station for a user equipment in a dual connectivity system, wherein the method comprises:
if a master base station determines that a secondary base station that jointly provides a dual-connectivity service to the user equipment therewith needs change, transmitting a release request to the secondary base station;
transmitting, by the secondary base station, a release response to the master base station;
transmitting, by the secondary base station, its SN status and forwarding data about the user equipment;
selecting, by the master base station, one base station to transmit an add request, which add request is for requesting for adding this base station as a secondary base station that jointly provides the dual connectivity service to the user equipment with the master base station;
transmitting, by the base station receiving the add request, an add response to the master base station, so as to be a new secondary base station of the master base station;
receiving, by the new secondary base station, the SN status and the data, and establishing a connection with the user equipment;
wherein the method further comprises:
forwarding, by the master base station, release acknowledgement information of the secondary base station transmitted by the user equipment, to the secondary base station, and forwarding add acknowledgement information of the new secondary base station transmitted by the user equipment to the new secondary base station.

20.-23. (canceled)

24. A dual connectivity system, a user equipment being capable of handing over from the source base station to the target base station in the dual connectivity system, wherein both of the source base station and the target base station support a dual connectivity configuration, the source base station comprising:
a device configured to, after determining, with a target base station, that the user equipment needs handover, transmit connection reconfiguration information to the user equipment, and transmit a release request to a secondary base station jointly providing the dual connectivity service to the user equipment with the source base station;
a device configured to transmit SN status to the target base station, and forward data about the user equipment;
wherein the secondary base station of the source base station comprises:
a device configured to transmit a release response to the source base station;
wherein the target base station comprises:
a device configured to receive the transmitted SN status and the forwarded data from the source base station, and establish a connection with the user equipment;
a device configured to transmit an add request to a base station, which add request is for requesting for adding this base station as a secondary base station jointly providing the dual connectivity service to the user equipment with the target base station;
wherein the secondary base station receiving the add request comprises:
a device configured to transmit an add response to the target base station, so that the base station receiving the add request establishes a connection with the user equipment as the secondary base station of the target base station.

25. A dual connectivity system, a user equipment being capable of handing over from a source base station to a target base station in the dual connectivity system, wherein the source base station supports a dual connectivity configuration, the target base station does not support the dual connectivity configuration, the source base station comprising:
a device configured to, after determining, with the target base station, that the user equipment needs handover, transmit connection reconfiguration information to the user equipment, and transmit a release request to a secondary base station jointly providing the dual connectivity service for the user equipment with the source base station;
a device configured to transmit SN status and forward data about the user equipment to the target base station, which SN status and data include the SN status and data of the source base station itself, or include the SN status and data of the source base station itself and the SN status and data transmitted from the secondary base station to the source base station;
wherein the secondary base station of the source base station comprises:
a device configured to transmit a release response to the source base station, and transmit its SN status and forward data about the user equipment to the source base station or target base station;
wherein the target base station comprises:
a device configured to receive the transmitted SN status and the forwarded data from the source base station, or the transmitted SN status and the forwarded data from the secondary base station and the source base station, and establish a connection with the user equipment.

26. A dual connectivity system, a user equipment being capable of handing over from the source base station to the target base station in the dual connectivity system, wherein the source base station supports a dual connectivity configuration, the secondary base station jointly providing service to the user equipment with the source base station under the dual connectivity configuration is the same base station as the target base station, the source base station comprises:
a device configured to, after determining, with the target base station, that the user equipment needs handover, transmit connection reconfiguration information to the user equipment, and transmit a release request to the target secondary base station, which release request is for requesting the target base station to release its connectivity as a secondary base station to the user equipment;
a device configured to transmit SN status to the target base station, and forward data about the user equipment;
wherein the target base station comprises:
a device configured to transmit a release response to the source base station, and store its SN status and the data about the user equipment into itself;
a device configured to receive the transmitted SN status and the forwarded data from the source base station.

27. A dual connectivity system, a user equipment being capable of handing over from a source base station to a target base station in the dual connectivity system, wherein the target base station supports a dual connectivity configuration, which source base station does not support the dual-connectivity configuration, the source base station comprises:
a device configured to transmit a handover request to the target base station;
a device configured to transmit SN status to the target base station, and forward data about the user equipment, and transmit connection reconfiguration information to the user equipment;
wherein the target base station comprises:
a device configured to transmit a handover request acknowledgement to the source base station;
a device configured to receive the transmitted SN status and the forwarded data from the source base station, and establish a connection with the user equipment;
a device configured to transmit an add request to a base station, which add request is for requesting for adding this base station as a secondary base station that jointly provides, with the target base station, the dual connectivity service to the user equipment;
wherein the base station receiving the add request comprises:
a device configured to transmit an add response to the target base station, such that the base station receiving the add request establishes a connection with the user equipment as the secondary base station of the target base station.

28. A dual connectivity system, a user equipment being capable of handing over from one cell to a further cell in the dual connectivity system, wherein the cell and the further cell belong to the same base station, and the base station supports dual connectivity configuration, the base station comprises:
a device configured to transmit a release request to the secondary base station jointly providing the dual connectivity service to the user equipment with the base station, if it is determined that the user equipment needs to handover from one cell of the base station to the further cell;
a device configured to transmit an add request to the secondary base station, after the handover of the user equipment is completed;
wherein the secondary base station comprises:
a device configured to transmit a release response to the base station; and
a device configured to transmit an add response to the base station, thereby reestablishing its connection with the base station.

29. A base station, a user equipment being capable of handing over from one cell of the base station to a further cell, wherein the cell and the further cell belong to the same base station, and the base station supports a dual connectivity configuration, the base station comprises:
a device configured to, if it is determined that the user equipment needs to handover from one cell of the base station to a further cell, transmit an instruction of stopping transmission to a secondary base station jointly providing a dual connectivity service for the user equipment with the base station;
a device configured to, after the handover of the user equipment is completed, transmit reconfiguration information and an instruction of initiating transmission to the secondary base station so as to re-establish a connection between the base station and the secondary base station, and resuming data transmission of the secondary base station.

30. A dual connectivity system, in which a secondary base station for a user equipment may be changed, wherein the master base station comprises:
a device configured to, if it is determined that a secondary base station that jointly provides a dual connectivity service to the user equipment therewith needs change, transmit a release request to the secondary base station;
a device configured to select one base station to transmit an add request, which add request is for requesting for adding this base station as a secondary base station that jointly provides the dual connectivity service to the user equipment with the master base station;
a device configured to forward release acknowledgement information of the secondary base station transmitted by the user equipment to the secondary base station, and forward add acknowledgement information of the new secondary base station transmitted by the user equipment to the new secondary base station;
wherein the secondary base station comprises:
a device configured to transmit a release response to the master base station;
a device configured to transmit its SN status and forward data about the user equipment;
wherein the base station receiving an add request comprises:
a device configured to receive the add response to the master base station, so as to be a new secondary base station of the master base station;
a device configured to receive the SN status and the data, and establish a connection with the user equipment.
